(19) United States
(12) Patent Application Publication
(10) Pub. No.: US 2026/0021619 A1
(43) Pub. Date: Jan. 22, 2026

(54) MOLDING METHOD FOR TPU FABRIC SHOE UPPER

(71) Applicant: JiangXi CAIBO Knitting Co., Ltd., Nanchang (CN)

(72) Inventor: Yi JIANG, Nanchang (CN)

(73) Assignee: JiangXi CAIBO Knitting Co., Ltd., Nanchang (CN)

(21) Appl. No.: 19/182,661

(22) Filed: Apr. 18, 2025

(30) Foreign Application Priority Data
Jul. 22, 2024 (CN) 202410983622.4

(51) Int. Cl. B29C 48/154; B29C 39/00; B29C 39/02; B29C 48/00; B29C 48/05; B29C 48/88; B29D 35/12; B29K 75/00; B29K 105/08; D03D 23/00; D06B 1/00

(52) U.S. Cl. CPC B29C 48/154; B29C 39/003; B29C 39/02; B29C 48/0022; B29C 48/022; B29C 48/05; B29C 48/911; D03D 23/00; D06B 1/00; B29D 35/126; B29K 2075/00; B29K 2105/08; D10B 2331/04; D10B 2501/043

(57) ABSTRACT

A molding method for a TPU fabric shoe upper includes: S1, preparing the composite yarn, adding the TPU raw material to the extruder, sliding the yarn through the molding head of the extruder, melting the TPU and coating a molten TPU on the outside of the yarn, forming the composite yarn after cooling by a cooling device; S2, weaving, installing the composite yarn reels with the same color or different colors on a knitting machine and weaving into fabric through the knitting machine; S3, cutting into samples, cutting the fabric into the required size of the need according to requirements, obtaining the sample; S4, molding, putting the sample into a mold of the molding machine, closing the mold and adding pressure, melting the TPU in the sample, and obtaining a shoe upper blank sample after cooling; S5, cutting, cutting the shoe upper blank sample to obtain the shoe upper.

### CROSS REFERENCE TO THE RELATED APPLICATIONS

This application is based upon and claims priority to Chinese Patent Application No. 202410983622.4, filed on Jul. 22, 2024, the entire contents of which are incorporated herein by reference.

### TECHNICAL FIELD

The invention relates to shoe upper molding technology, particularly, a molding method for a thermoplastic urethane (TPU) fabric shoe upper.

### BACKGROUND

The production of fabric shoe uppers is generally made of directly cut knitted fabric, and then the knitted fabric is sewn and spliced into the upper structure, the preparation process of the TPU foam shoe upper includes cutting TPU into pieces, then pressing the TPU foam to the required concave and convex shapes, then cutting the TPU pieces to obtain the TPU samples, and finally hot pressing is performed on the TPU sample with the knitted shoe upper to form the shoe upper. The TPU shoe upper prepared by the above method is not only complicated in process, long in production cycle, time-consuming, and laborious, but also has poor stability of adhesion between TPU and shoe upper, which is easy to cause the separation of TPU and shoe upper and affect the quality of shoe upper. Moreover, when the TPU sample is bonded with the upper, the position of the TPU sample is easy to move, which affects the bonding effect; it is also susceptible to human factors, resulting in poor quality stability and a high abnormal rate of shoe uppers.

The existing patent CN202111586114.5 discloses a process for sports shoe uppers, firstly, the E-TPU sheet is cut out of the upper shape, and then multiple first positioning through holes are set on its edge, the positioning is performed by setting the hanging nails corresponding to the first positioning through holes on the vacuum suction mold, and the protruding part is made on the surface of the E-TPU sheet by the first vacuum suction, then, the lower surface of the E-TPU sheet after vacuum suction is completed is bonded with the stereotyped cloth by hot melt bonding, so that the edge of the protruding part is attached to the stereotyped cloth, the E-TPU sheet and the stereotyped cloth are fixed on the vacuum suction mold together, through the second vacuum plastic absorption, the secondary reinforcement is finalized. Through the above process, the protruding part with a stable structure can be processed. It can not only ensure that athletes can bend their feet flexibly to carry out various complex footwork without being bound, but also provide effective protection for athletes' feet. In the above patent, the preparation of shoe uppers requires separate treatment of TPU sheets, the production process is complex and the production efficiency is low.

### SUMMARY

The purpose of the invention is to provide a molding method for a TPU fabric shoe upper to solve the problems of the existing TPU fabric shoe upper's complex production process and low production efficiency.

To achieve the above purpose, the invention provides a molding method for a TPU fabric shoe upper, which comprises the following steps:
S1, preparing a composite yarn, adding a TPU raw material to an extruder, sliding a yarn through a molding head of the extruder, heating the TPU raw material by the extruder, and melting the TPU and coating a molten TPU on an outside of the yarn, forming the composite yarn after cooling by a cooling device, and rolling the composite yarn to obtain a composite yarn reel;
S2, weaving, installing the composite yarn reels with the same color or different colors on a knitting machine and weaving into fabric through the knitting machine;
S3, cutting into samples, cutting the fabric into a required size of the need according to requirements, obtaining a sample;
S4, molding, putting the sample into a mold of a molding machine, closing the mold and adding pressure, melting the TPU in the sample, and obtaining a shoe upper blank sample after cooling;
S5, cutting, cutting the shoe upper blank sample to obtain the shoe upper.

Preferably, in S1, the extruder is heated from a feed end to a discharge end in four zones, a heating temperature of a first zone is 175° C.-183° C., the heating temperature of a second zone is 182° C.-188° C., the heating temperature of a third zone is 175° C.-183° C., and the heating temperature of a fourth zone is 180° C.-190° C.

Preferably, in S1, a screw speed of the extruder is 30 r/min-100 r/min.

Preferably, in S1, the yarn is polyester or aramid, and a fineness of the composite yarn is 75 D-150 D.

Preferably, in S4, a molding temperature is 170° C.-220° C., and a molding time is 30 s-60 s.

Preferably, the cooling device includes a water-cooling mechanism, the water-cooling mechanism is arranged at the discharge end of the extruder, a spray mechanism for cooling the composite yarn is arranged above the water-cooling mechanism, and an air-drying mechanism for air-drying the composite yarn is arranged at an yarn outlet end of the water-cooling mechanism; the water-cooling mechanism includes a cooling box, the cooling box is arranged on the supporting frame, and a water tank is arranged below the supporting frame, an yarn inlet port is arranged at one end of the cooling box near the extruder, and an yarn outlet port is arranged at the other end of the cooling box, two ends of the cooling box are arranged with a return water tank, the return water tank is connected to the water tank through a return water pipe, and the water tank is connected to the cooling box through a water pump and an water inlet pipe, a bottom of the cooling box is rotated with a rotating shaft, and a spiral blade is arranged on the rotating shaft to agitate the water in the cooling box, a side wall of the cooling box is rotated with a limit roller to support and limit the composite yarn, the supporting frame is equipped with a transmission structure that drives the rotating shaft, and the spray mechanism and the air-drying mechanism are connected to the transmission structure.

Preferably, the spray mechanism includes several spray units in a linear array above the cooling box, the spray unit includes an installation plate, the installation plate rotates on a fixed rod, two ends of the fixed rod are connected to the cooling box through the supporting plate, a bottom of the installation plate is provided with a nozzle, the nozzle is connected to a water source or the water tank through a connecting pipe, the nozzle is located directly above the composite yarn, a sliding rod is slidingly set on the supporting plate, the supporting plate is provided with a limiting plate, the limiting plate has a limiting and guiding effect on the sliding of the sliding rod, a sliding groove is arranged on a side of the sliding rod, and the limiting plate is located in the sliding groove and slides with the sliding groove, a fixed pin is arranged on the sliding rod, a sliding groove is arranged on the installation plate, the fixed pin is located in the sliding groove and slides along the sliding groove, the sliding rod drives the installation plate to rotate through the fixed pin and sliding groove, the sliding rod is connected to the transmission structure, and the transmission structure drives the sliding rod to slide horizontally and reciprocally.

Preferably, the air-drying mechanism includes a fixed seat, the fixed seat is set on the supporting frame, an interior of fixed seat is rotatively set with a rotary drum, the rotary drum is coaxially set with the yarn inlet port and yarn outlet port, the rotary drum is connected to the transmission structure, and the transmission structure drives the rotary drum to rotate, several air-drying units are set inside the rotary drum in a circular array, the air-drying unit includes an installation shaft, two ends of the installation shaft are rotatively connected to a connecting plate, and the connecting plate is fixed on an inner wall of the rotary drum, several fan blades are evenly set on the installation shaft, an end of the installation shaft is set with a fourth gear, the fourth gear is engaged with a second geared ring set on the installation frame, and the installation frame is fixed on the fixed seat, the installation frame is coaxially arranged with the rotary drum.

Preferably, the transmission structure includes a motor, the motor is arranged on the supporting frame, an output end of the motor is provided with a first gear, the first gear is engaged with a second gear set on the rotating shaft, a terminal of the rotating shaft is provided with a third gear, the third gear is engaged with a first geared ring set on an inner wall of the rotary drum, a first transmission wheel is set on the rotating shaft, the first transmission wheel is connected to a second transmission wheel through a transmission belt, the second transmission wheel is rotatively set on a first fixed plate, the first fixed plate is connected to the cooling box, a first bevel gear is set on an axle of the second transmission wheel, the first bevel gear is engaged with a second bevel gear set on a second fixed plate, the second fixed plate is fixedly connected to the first fixed plate, a rotary disc is set on the axle of the second bevel gear, the rotary disc is hinged with a sliding rod through the connecting rod, and the connecting rod is eccentrically set on the rotary disc.

Preferably, a cooling method for the cooling device includes the following steps:
S11, entering the composite yarn extruded by the extruder to the cooling box through the yarn inlet port, passing the composite yarn between the two limit rollers, and entering the composite yarn from the yarn outlet port to the rotary drum and rolling through the rotary drum on the winder;
S12, flowing cooling water in the cooling box into the return water tank through the yarn inlet port and yarn outlet port, and then flowing the cooling water in the return water tank into the water tank through the return water pipe, and entering the water in the water tank into the cooling box through the water pump and the water inlet pipe to realize a circulating flow of cooling water; driving the rotating shaft to rotate by the motor through the first gear and the second gear, and driving the spiral blade to rotate by the rotating shaft, stirring the cooling water in the cooling box by the spiral blade to improve uniformity of the cooling water.
S13, driving the first bevel gear to rotate by the rotating shaft through the first transmission wheel and the second transmission wheel, driving the rotary disc to rotate by the first bevel gear through the second bevel gear, driving the sliding rod to slide horizontally and reciprocally by the rotary disc through the connecting rod, driving the installation plate to swing around the fixed rod by the sliding rod through the fixed pin and the sliding groove, driving the nozzle to swing synchronously and reciprocally by the installation plate, spraying the cooling water above the composite yarn through the nozzle to cool the composite yarn.
S14, driving the rotary drum to rotate by the rotating shaft through the third gear and the first geared ring, driving the installation shaft to rotate synchronously by the rotary drum through the connecting plate, rotating the installation shaft under an action of the fourth gear and the second geared ring, driving the fan blade to rotate by the installation shaft, and performing air cooling and blowing to the composite yarn by the fan blade.

The advantages and positive effects of the molding method for a TPU fabric shoe upper described in the invention are as follows:
1. The invention uses TPU composite yarn to weave the shoe upper, and then prepares the shoe upper by molding, the production process is simple, which is beneficial to improve production efficiency, improve shoe upper quality, and reduce labor force.
2. The shoe upper produced by the invention has good tensile strength and elongation, strong tear resistance, good three-color stability, good wear resistance, and good bending resistance.
3. The invention uses a combination of cold water tank, nozzle, and air-drying to cool the composite yarn, which improves the cooling effect of the composite yarn and is conducive to improving the production efficiency and production quality of the composite yarn.

The following is a further detailed description of the technical scheme of the invention through drawings and an embodiment.

### BRIEF DESCRIPTION OF THE DRAWINGS

FIG. 1 is a schematic diagram of the production process in the embodiment of the invention;

FIG. 2 is a shoe sample prepared by the embodiment of the invention;

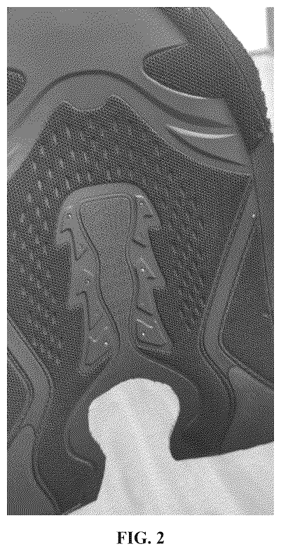

FIG. 3 is a schematic diagram of the three-dimensional structure of the cooling device in the embodiment of the invention;

FIG. 4 is a schematic diagram of the top view structure of the cooling device in the embodiment of the invention;

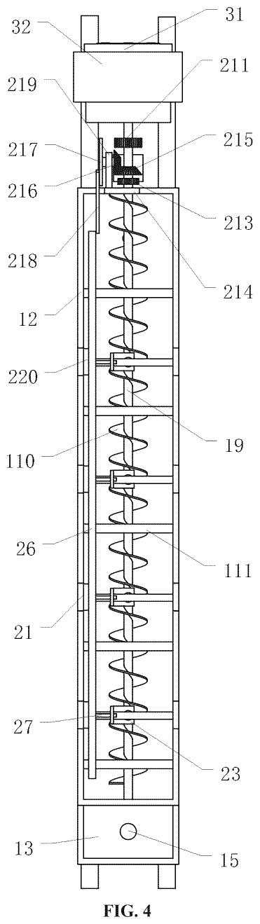

FIG. 5 is a schematic diagram of the cross-section structure of the cooling device in the embodiment of the invention;

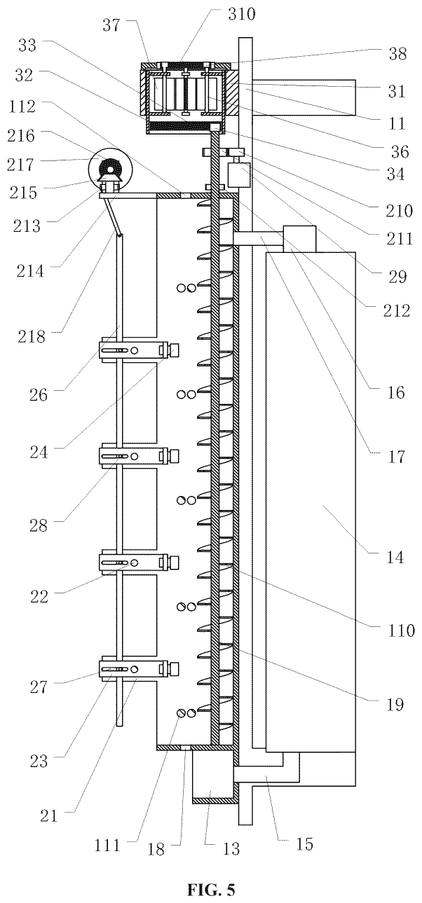

FIG. 6 is a schematic diagram of the three-dimensional structure of the air-drying mechanism in the embodiment of the invention;

FIG. 7 is a schematic diagram of the transmission structure in the embodiment of the invention;

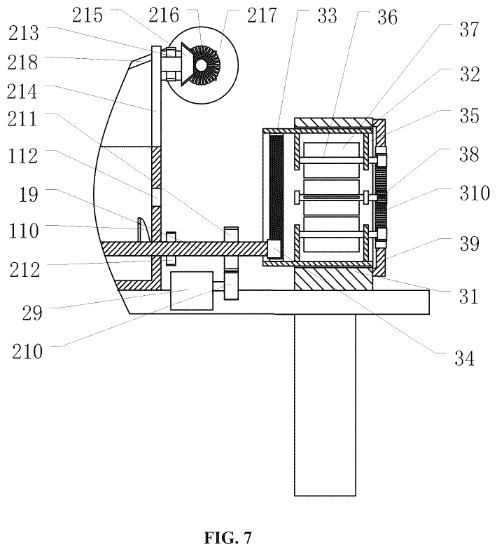

FIG. 8 is a schematic diagram of the cross-section structure of the air-drying mechanism in the embodiment of the invention.

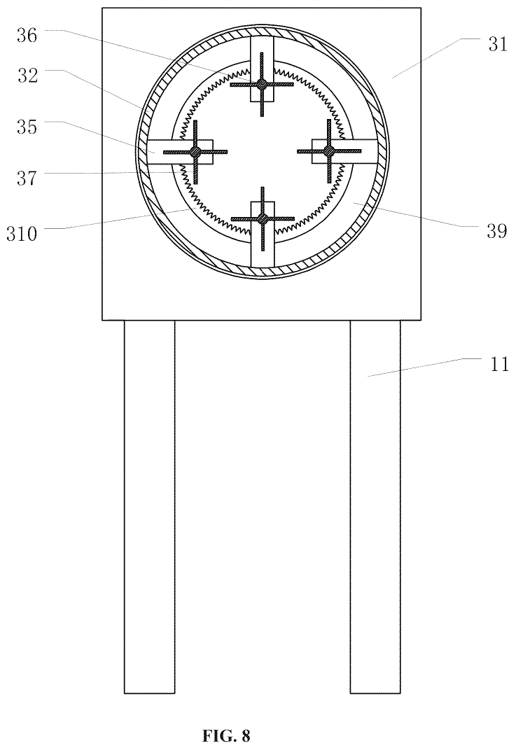

### MARKS IN THE FIGURES

1, water-cooling mechanism; 11, supporting frame; 12, cooling box; 13, return water tank; 14, water tank; 15, return water pipe; 16, water pump; 17, water inlet pipe; 18, yarn inlet port; 19, rotating shaft; 110, spiral blade; 111, limit roller; 112, yarn outlet port;
2, spraying mechanism; 21, supporting plate; 22, fixed rod; 23, installation plate; 24, nozzle; 25, connecting pipe; 26, sliding rod; 27, sliding groove; 28, fixed pin; 29, motor; 210, the first gear; 211, the second gear; 212, the first transmission wheel; 213, the second transmission wheel; 214, the first fixed plate; 215, the first bevel gear; 216, second bevel gear; 217, rotary disc; 218, connecting rod; 219, the second fixed plate; 220, limiting plate;
3, air-drying mechanism; 31, fixed seat; 32, rotary drum; 33, the first geared ring; 34, the third gear; 35, connecting plate; 36, installation shaft; 37, fan blade; 38, the fourth gear; 39, installation frame; 310, the second geared ring.

### DETAILED DESCRIPTION OF THE EMBODIMENTS

The following is a further explanation of the technical scheme of the invention through drawings and an embodiment.

Unless otherwise defined, the technical terms or scientific terms used in the invention should be understood by people with general skills in the field to which the invention belongs. The words first, second, and the like used in this invention do not represent any order, quantity, or importance, but are only used to distinguish different components. Similar words such as include or comprise mean that the elements or objects appearing before the word cover the elements or objects listed after the word and their equivalents, without excluding other elements or objects. Similar terms such as connected or connecting are not limited to physical or mechanical connections, but can include electrical connections, whether direct or indirect. Up, down, left, right, etc. are only used to represent the relative positional relationship. When the absolute position of the described object changes, the relative positional relationship may also change accordingly.

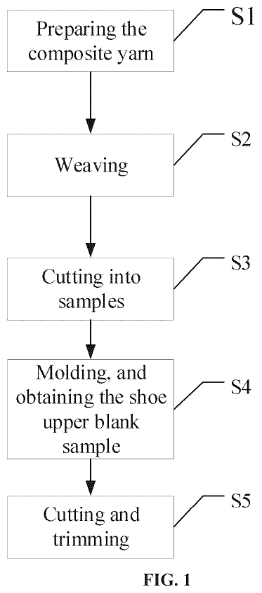

As shown in FIG. 1. a molding method for a TPU fabric shoe upper includes the following steps:
S1, the composite yarn was prepared. The TPU raw material was added to the extruder, and the yarn was slid through the molding head of the extruder, the extruder heated the TPU raw material, the TPU was melted and the molten TPU was coated on the outside of the yarn after passing through the molding head, the composite yarn was formed after cooling by a cooling device, and the composite yarn was rolled to obtain a composite yarn reel.

The extruder was heated from the feed end to the discharge end in four zones, the heating temperature of the first zone was 175° C.-183° C., the heating temperature of the second zone was 182° C.-188° C., the heating temperature of the third zone was 175° C.-183° C., and the heating temperature of the fourth zone was 180° C.-190° C. Preferably, the heating temperature of the first zone was 180° C., the heating temperature of the second zone was 185° C., the heating temperature of the third zone was 180° C., and the heating temperature of the fourth zone was 180° C.-190° C.

The yarn was polyester or aramid. Polyester and aramid had high melting temperatures, while ensuring the properties of polyester and aramid, TPU could be well coated on the outer surface of polyester and aramid.

The screw speed of the extruder was 30 rpm-100 rpm. The screw speed of the extruder was related to the thickness of the yarn, according to the thickness of the yarn, the corresponding screw speed was selected to achieve a good coating of TPU on the yarn. The fineness of the composite yarn was 75 D-150 D.

The composite yarn was cooled after extrusion from the extruder, the existing cooling method generally directly cooled the yarn through the water tank 14, because the cooling effect of the water tank 14 was limited, it is necessary to set a longer water tank 14 for cooling, it led to a long cooling process, which not only covers a large area, but also affects the preparation efficiency of the composite yarn.

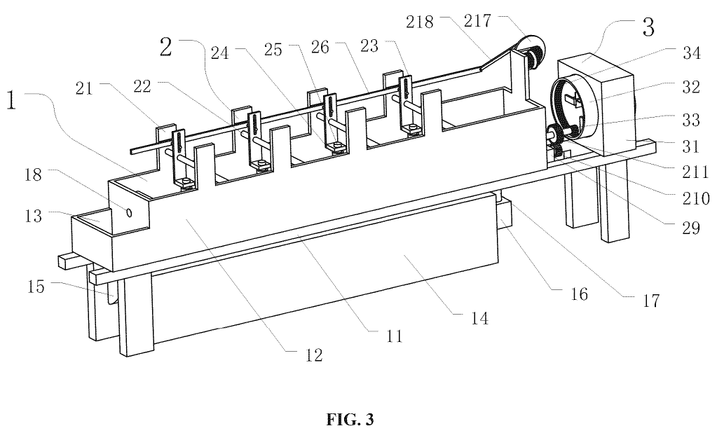

The invention improved the cooling process of the composite yarn, designed a new cooling device, improved the cooling effect of the composite yarn, reduced the occupied area, and improved the production efficiency of the composite yarn. As shown in FIGS. 3,4,5. The cooling device included a water-cooling mechanism 1, the water-cooling mechanism 1 was arranged at the discharge end of the extruder, a spray mechanism 2 for cooling the composite yarn was arranged above the water-cooling mechanism 1, and the spray mechanism 2 cooled the composite yarn from the top to improve the cooling effect. An air-drying mechanism 3 for air-drying the composite yarn was arranged at a yarn outlet end of the water-cooling mechanism 1, the air-drying mechanism 3 performed the final air-cooling and air-drying of the composite yarn to reduce the moisture content of the composite yarn.

The water-cooling mechanism 1 included a cooling box 12, the cooling box was arranged on the supporting frame 11, and the supporting frame 11 was fixed on the ground. A water tank 14 was arranged below the supporting frame 11, a yarn inlet port 18 was arranged at one end of the cooling box 12 near the extruder, and a yarn outlet port 112 was arranged at the other end of the cooling box 12, the yarn inlet port 18 and the yarn outlet port 112 were in the same straight line. Two ends of the cooling box 12 were arranged with a return water tank 13, the return water tank 13 was connected to the water tank 14 through a return water pipe 15, the cooling water overflowed from the yarn inlet port 18 and the yarn outlet port 112 of the cooling box 12 flowed into the return water tank 13, and the cooling water in the return water tank 13 flowed back into the water tank 14 through the return water pipe 15. The water tank 14 was connected to the cooling box 12 through a water pump 16 and a water inlet pipe 17 to realize the circulation of cooling water. The bottom of the cooling box 12 was rotated with a rotating shaft 19, and a spiral blade 110 was arranged on the rotating shaft 19 to agitate the water in the cooling box 12, the cooling water in the water tank 14 entered the bottom of the cooling tank 12, and the cooling water in the cooling tank 12 was stirred by the spiral blade 110 to improve the uniformity of the cooling water in the cooling tank 12. The side wall of the cooling box 12 was rotated with a limit roller 111 to support and limit the composite yarn, and the composite yarn passed through between the limiting roller 111. The spacing between the limiting rollers 111 was slightly larger than the diameter of the yarn.

The supporting frame 11 was equipped with a transmission structure that drives the rotating shaft 19 to rotate, and the spray mechanism 2 and the air-drying mechanism 3 were connected to the transmission structure.

The spray mechanism 2 included several spray units in a linear array above the cooling box 12. The spray unit included an installation plate 23, the installation plate 23 rotated on a fixed rod 22, and two ends of the fixed rod 22 were connected to the cooling box 12 through the supporting plate 21. The bottom of the installation plate 23 was provided with a nozzle 24, the nozzle 24 was connected to a water source or the water tank 14 through a connecting pipe 25. The nozzle 24 was located directly above the composite yarn, and the composite yarn was sprayed and cooled by the nozzle 24. A sliding rod 26 was slidingly set on the supporting plate 21, the supporting plate 21 was provided with a limiting plate 220, and the limiting plate 220 had a limiting and guiding effect on the sliding of the sliding rod 26. A sliding groove 27 was arranged on the side of the sliding rod 26, and the limiting plate 220 was located in the sliding groove 27 and slides with the sliding groove 27. A fixed pin 28 was fixedly arranged on the sliding rod 26, and a long strip sliding groove 27 was arranged on the installation plate 23, the fixed pin 28 was located in the sliding groove 27 and slid along the sliding groove 27. The sliding rod 26 drove the installation plate 23 to rotate through the fixed pin 28 and sliding groove 27, the sliding rod 26 was connected to the transmission structure, and the transmission structure drove the sliding rod 26 to slide horizontally and reciprocally.

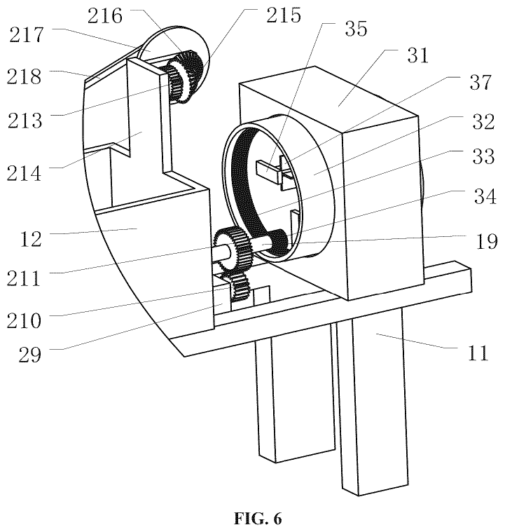

As shown in FIGS. 6,7,8. The air-drying mechanism included a fixed seat 31, the fixed seat 31 was fixedly set on the supporting frame 11, the interior of fixed seat 31 was rotatively set with a rotary drum 32, the rotary drum 32 was coaxially set with the yarn inlet port 18 and yarn outlet port 112. The rotary drum 32 was connected to the transmission structure, and the transmission structure drove the rotary drum 32 to rotate, several air-drying units were set inside the rotary drum 32 in a circular array, and four air-drying units were set in this embodiment. The air-drying unit included an installation shaft 36, two ends of the installation shaft 36 were rotatively connected to a connecting plate 35 through a bearing, and the connecting plate 35 was fixed on an inner wall of the rotary drum 32, several fan blades 37 were evenly set on the installation shaft 36. The end of the installation shaft 36 was set with the fourth gear 38, the fourth gear 38 was engaged with the second geared ring 310 set on the installation frame 39, and the installation frame 39 was fixed on the fixed seat 31, the installation frame 39 was coaxially arranged with the rotary drum 32.

The transmission structure included a motor 29, and the motor 29 was fixedly arranged on the supporting frame 11. The output end of the motor 29 was provided with the first gear 210, the first gear 210 was engaged with the second gear 211 set on the rotating shaft 19, the motor 29 drove the rotating shaft 19 to rotate through the first gear 210 and the second gear 211, and the rotating shaft 19 drove the spiral blade 110 to rotate, thereby stirring the cooling water. The terminal of the rotating shaft 19 was provided with a third gear 34, the third gear 34 was engaged with a first geared ring 33 set on an inner wall of the rotary drum 32, and the rotating shaft 19 drove the rotary drum 32 to rotate through the third gear 34 and the first ring 33. The first transmission wheel 212 was set on the rotating shaft 19, the first transmission wheel 212 was connected to a second transmission wheel 213 through a transmission belt, the second transmission wheel 213 was rotatively set on a first fixed plate 214, the first fixed plate 214 was connected to the cooling box 12. The first bevel gear 215 was set on the axle of the second transmission wheel 213, the first bevel gear 215 was engaged with the second bevel gear 216 set on the second fixed plate 219, the second fixed plate 219 was fixedly connected to the first fixed plate 214. A rotary disc 217 was set on the axle of the second bevel gear 216, the rotary disc 217 was hinged with a sliding rod 26 through the connecting rod 218, and the connecting rod 218 was eccentrically set on the rotary disc 217.

The cooling method of the cooling device included the following steps:
S11, the composite yarn extruded by the extruder entered the cooling box 12 through the yarn inlet port 18, the composite yarn passed between the two limit rollers 111, the composite yarn entered the rotary drum 32 from the yarn outlet port 112 and rolled on the winding machine through the rotary drum 32. The rewinder adopts the existing structure.
S12, the cooling water in the cooling box 12 were flown into the return water tank 13 through the yarn inlet port 18 and yarn outlet port 112, and then the cooling water in the return water tank 13 were flown into the water tank 14 through the return water pipe 15, and the water in the water tank 14 entered into the cooling box 12 through the water pump 16 and the water inlet pipe 17 to realize the circulating flow of cooling water. The rotating shaft 19 was driven to rotate by the motor 29 through the first gear 210 and the second gear 211, and the spiral blade 110 was driven to rotate by the rotating shaft 19, the spiral blade stirred the cooling water in the cooling box 12 to improve uniformity of the cooling water.
S13, the first bevel gear 215 was driven to rotate by the rotating shaft 19 through the first transmission wheel and 212 the second transmission wheel 213, the rotary disc 217 was driven to rotate by the first bevel gear 215 through the second bevel gear 216, the sliding rod 26 was driven to slide horizontally and reciprocally by the rotary disc 217 through the connecting rod 218, the installation plate 23 was driven to swing around the fixed rod 22 by the sliding rod 26 through the fixed pin 28 and the sliding groove 27, the nozzle 24 was driven to swing synchronously and reciprocally by the installation plate 23, the cooling water above the composite yarn was sprayed through the nozzle 24 to cool the composite yarn.
S14, the rotary drum 32 was driven to rotate by the rotating shaft 19 through the third gear 34 and the first geared ring 33, the installation shaft 36 was driven to rotate synchronously by the rotary drum 32 through the connecting plate 35, the installation shaft 36 was rotated under an action of the fourth gear 38 and the second geared ring 310, the fan blade 37 was driven to rotate by the installation shaft 36, and the air cooling and blowing was performed to the composite yarn by the fan blade 37.
S2, weaving, the composite yarn reels with the same color or different colors were installed on a knitting machine and woven into fabric through the knitting machine.
S3, cutting into samples, the fabric was cut into the required size of the need according to requirements, and a sample was obtained.
S4, molding, the sample is put into a mold of the molding machine, the mold was closed and pressure was added, the TPU was melted in the sample, and a shoe upper blank sample after cooling was obtained.

The molding temperature was 170° C.-220° C., and the molding time was 30 s-60 s. By molding the sample, the TPU in the composite yarn directly in contact with the mold melted under the action of high temperature, and the melted TPU was bonded together to form a TPU patch with the required shape in the mold. The TPU in the composite yarn that does not contact directly with the mold maintained the original mesh shape. The TPU fabric shoe upper produced by the molding method has good integration and high molding quality, it meets the needs of air permeability while ensuring good wear resistance and protective effect of the upper. The specific shape of the TPU patch on the upper of the shoe is set as needed.
S5, cutting and trimming, the shoe upper blank sample was cut and trimmed to obtain the shoe upper.

The invention can also prepare a multi-color upper, according to the design requirements, the patterned TPU patch and the sample were placed together in a molding mold and hot-pressed together.

### Embodiment

The molding method for the TPU fabric shoe upper includes the following steps:
S1, the composite yarn was prepared, the TPU raw material was added to the extruder, and the yarn was slid through the molding head of the extruder, the extruder heated the TPU raw material, the TPU was melted and the molten TPU was coated on the outside of the yarn, the composite yarn was formed after cooling by a cooling device, and rolling the composite yarn to obtain a composite yarn reel.

The heating temperature of the first zone of the extruder was 180° C., the heating temperature of the second zone was 185° C., the heating temperature of the third zone was 180° C., and the heating temperature of the fourth zone was 190° C.

The yarn is polyester. The screw speed of the extruder is 50 r/min. The fineness of the composite yarn is 100 D.
S2, weaving, the composite yarn reels with the same color or different colors were installed on a knitting machine and woven into fabric through the knitting machine;
S3, cutting into samples, the fabric was cut into a required size of the need according to requirements, and a sample was obtained;
S4, molding, the sample was put into a mold of the molding machine, the mold was closed and pressure was added, the TPU was melted in the sample, and a shoe upper blank sample was obtained after cooling;
S5, cutting, the shoe upper blank sample was cut to obtain the shoe upper.

The performance of the uppers prepared by this embodiment was tested, and the test results were shown in Table 1.

TABLE 1
Performance of shoe upper prepared by embodiment

| | | Shoe upper | |
|---|---|---|---|
| Test project | Test conditions | standard | Test results |
| Tension (kg/cm) | Length | 4.5 | 16 |
| | Width | 4.5 | 16 |
| Elongation (%) | Length | 20 | 107 |
| | Width | 20 | 108 |
| Tearing force (kg) | Length | 1.2 | 4 |
| | Width | 1.2 | 4 |
| Resistant to sweat | Dyeing through | 4 | 4 |
| (AATCC rating) | | | |
| Color drift (AATCC | Dyeing through | 4 | 4 |
| rating) | | | |
| Martindale wear | Drying | 25600X | 40000 |
| resistance (cycle) | | 6400X | By |
| Bending resistance | WTM92 | No cracks | No cracks after |
| (room temperature) | | | 400,000 bends |
| Bending resistance | WTM92 | No cracks | No cracks after |
| (−20° C.) | | | 300,000 bends |

The upper and the sole were compounded into finished shoes, and the bending resistance of the finished shoes was tested. The test results were shown in Table 2.

TABLE 2
Bending resistance of finished shoes prepared by
using the shoe upper prepared by the embodiment.

| Test project | Testing method | Standards | Test results |
|---|---|---|---|
| Bending resistance | WTM92 | No cracks | No cracks after |
| (room temperature) | | | 400,000 bends |
| Bending resistance | WTM92 | No cracks | No cracks after |
| (−20° C.) | | | 300,000 bends |

Therefore, the molding method for the TPU fabric shoe upper described in the invention can solve the problems of complex production process and low production efficiency of the existing TPU fabric shoe upper.

Finally, it should be explained that the above embodiment is only used to explain the technical scheme of the invention rather than restrict it. Although the invention is described in detail concerning the better embodiment, the ordinary technical personnel in this field should understand that they can still modify or replace the technical scheme of the invention, and these modifications or equivalent substitutions cannot make the modified technical scheme out of the spirit and scope of the technical scheme of the invention.

What is claimed is:

1. A molding method for a thermoplastic urethane (TPU) fabric shoe upper, comprising the following steps:
S1, preparing a composite yarn, adding a TPU raw material to an extruder, sliding a yarn through a molding head of the extruder, heating the TPU raw material by the extruder, and melting the TPU raw material and coating a molten TPU on an outside of the yarn, forming the composite yarn after cooling by a cooling device, and rolling the composite yarn to obtain a composite yarn reel;
S2, weaving, installing the composite yarn reel with a same color or different colors on a knitting machine and weaving into fabric through the knitting machine;
S3, cutting into samples, cutting the fabric into a required size of a need according to requirements, obtaining a sample;
S4, molding, putting the sample into a mold of a molding machine, closing the mold and adding pressure, melting the TPU in the sample, and obtaining a shoe upper blank sample after cooling; and
S5, cutting, cutting the shoe upper blank sample to obtain the TPU fabric shoe upper.

2. The molding method for the TPU fabric shoe upper according to claim 1, wherein in S1, the extruder is heated from a feed end to a discharge end in four zones, a heating temperature of a first zone in the four zones is 175° C.-183° C., a heating temperature of a second zone in the four zones is 182° C.-188° C., a heating temperature of a third zone in the four zones is 175° C.-183° C., and a heating temperature of a fourth zone in the four zones is 180° C.-190° C.

3. The molding method for the TPU fabric shoe upper according to claim 2, wherein in S1, a screw speed of the extruder is 30 r/min-100 r/min.

4. The molding method for the TPU fabric shoe upper according to claim 3, wherein in S1, the yarn is polyester or aramid, and a fineness of the composite yarn is 75 D-150 D.

5. The molding method for the TPU fabric shoe upper according to claim 4, wherein in S4, a molding temperature is 170° C.-220° C., and a molding time is 30 s-60 s.

6. The molding method for the TPU fabric shoe upper according to claim 5, wherein the cooling device comprises a water-cooling mechanism, wherein the water-cooling mechanism is arranged at the discharge end of the extruder, a spray mechanism for cooling the composite yarn is arranged above the water-cooling mechanism, and an air-drying mechanism for air-drying the composite yarn is arranged at an yarn outlet end of the water-cooling mechanism; the water-cooling mechanism comprises a cooling box, wherein the cooling box is arranged on a supporting frame, and a water tank is arranged below the supporting frame; an yarn inlet port is arranged at a first end of the cooling box near the extruder, and an yarn outlet port is arranged at a second end of the cooling box; the first end and the second end of the cooling box are arranged with a return water tank, the return water tank is connected to the water tank through a return water pipe, and the water tank is connected to the cooling box through a water pump and an water inlet pipe; a bottom of the cooling box is rotated with a rotating shaft, and a spiral blade is arranged on the rotating shaft to agitate water in the cooling box; a side wall of the cooling box is rotated with a limit roller to support and limit the composite yarn, and the supporting frame is equipped with a transmission structure, wherein the transmission structure drives the rotating shaft, and the spray mechanism and the air-drying mechanism are connected to the transmission structure.

7. The molding method for the TPU fabric shoe upper according to claim 6, wherein the spray mechanism comprises a plurality of spray units in a linear array above the cooling box, and each of the plurality of spray units comprises an installation plate, wherein the installation plate rotates on a fixed rod, two ends of the fixed rod are connected to the cooling box through the supporting plate, a bottom of the installation plate is provided with a nozzle, the nozzle is connected to a water source or the water tank through a connecting pipe, the nozzle is located directly above the composite yarn, a sliding rod is slidingly set on the supporting plate, the supporting plate is provided with a limiting plate, the limiting plate has a limiting and guiding effect on sliding of the sliding rod, a first sliding groove is arranged on a side of the sliding rod, the limiting plate is located in the first sliding groove and slides with the first sliding groove, a fixed pin is arranged on the sliding rod, a second sliding groove is arranged on the installation plate, the fixed pin is located in the second sliding groove and slides along the second sliding groove, the sliding rod drives the installation plate to rotate through the fixed pin and the second sliding groove, the sliding rod is connected to the transmission structure, and the transmission structure drives the sliding rod to slide horizontally and reciprocally.

8. The molding method for the TPU fabric shoe upper according to claim 7, wherein the air-drying mechanism comprises a fixed seat, wherein the fixed seat is set on the supporting frame, an interior of the fixed seat is rotatively set with a rotary drum, the rotary drum is coaxially set with the yarn inlet port and the yarn outlet port, the rotary drum is connected to the transmission structure, and the transmission structure drives the rotary drum to rotate; a plurality of air-drying units are set inside the rotary drum in a circular array, and each of the plurality of air-drying units comprises an installation shaft, wherein two ends of the installation shaft are rotatively connected to a connecting plate, and the connecting plate is fixed on an inner wall of the rotary drum; a plurality of fan blades are evenly set on the installation shaft, an end of the installation shaft is set with a fourth gear, the fourth gear is engaged with a second geared ring set on an installation frame, the installation frame is fixed on the fixed seat, and the installation frame is coaxially arranged with the rotary drum.

9. The molding method for the TPU fabric shoe upper according to claim 8, wherein the transmission structure comprises a motor, wherein the motor is arranged on the supporting frame, an output end of the motor is provided with a first gear, the first gear is engaged with a second gear set on the rotating shaft, a terminal of the rotating shaft is provided with a third gear, the third gear is engaged with a first geared ring set on the inner wall of the rotary drum, a first transmission wheel is set on the rotating shaft, the first transmission wheel is connected to a second transmission wheel through a transmission belt, the second transmission wheel is rotatively set on a first fixed plate, the first fixed plate is connected to the cooling box, a first bevel gear is set on an axle of the second transmission wheel, the first bevel gear is engaged with a second bevel gear set on a second fixed plate, the second fixed plate is fixedly connected to the first fixed plate, a rotary disc is set on an axle of the second bevel gear, the rotary disc is hinged with a sliding rod through the connecting rod, and the connecting rod is eccentrically set on the rotary disc.

10. The molding method for the TPU fabric shoe upper according to claim 9, wherein, a cooling method for the cooling device comprises the following steps:
S11, entering the composite yarn extruded by the extruder to the cooling box through the yarn inlet port, passing the composite yarn between the two limit rollers, and entering the composite yarn from the yarn outlet port to the rotary drum and rolling through the rotary drum on a winder;
S12, flowing a cooling water in the cooling box into the return water tank through the yarn inlet port and the yarn outlet port, and then flowing the cooling water in the return water tank into the water tank through the return water pipe, and entering the water in the water tank into the cooling box through the water pump and the water inlet pipe to realize a circulating flow of the cooling water; driving the rotating shaft to rotate by the motor through the first gear and the second gear, driving the spiral blade to rotate by the rotating shaft, and stirring the cooling water in the cooling box by the spiral blade to improve uniformity of the cooling water;
S13, driving the first bevel gear to rotate by the rotating shaft through the first transmission wheel and the second transmission wheel, driving the rotary disc to rotate by the first bevel gear through the second bevel gear, driving the sliding rod to slide horizontally and reciprocally by the rotary disc through the connecting rod, driving the installation plate to swing around the fixed rod by the sliding rod through the fixed pin and the second sliding groove, driving the nozzle to swing synchronously and reciprocally by the installation plate, and spraying the cooling water above the composite yarn through the nozzle to cool the composite yarn; and
S14, driving the rotary drum to rotate by the rotating shaft through the third gear and the first geared ring, driving the installation shaft to rotate synchronously by the rotary drum through the connecting plate, rotating the installation shaft under an action of the fourth gear and the second geared ring, driving the plurality of fan blades to rotate by the installation shaft, and performing air cooling and blowing to the composite yarn by the plurality of fan blades.
